(19) United States
(12) Patent Application Publication
(10) Pub. No.: US 2003/0230630 A1
(43) Pub. Date: Dec. 18, 2003

(54) Using mobile electronic devices to transfer data through dynamically generated scannable barcode images

(76) Inventors: Larry Cale Whipple, Park City, UT (US); Verland Thayne Whipple II, Ojai, CA (US)

Correspondence Address: THAYNE WHIPPLE, 271 FAIRVIEW ROAD, OJAI, CA, 93023, US

(21) Appl. No.: 10/307,275

(22) Filed: Nov. 30, 2002

Related U.S. Application Data
(60) Provisional application No. 60/342,180, filed on Dec. 20, 2001.

(51) Int. Cl. G06K 7/10

(52) U.S. Cl. 235/462.01

(57) ABSTRACT

The invention allows users to transfer information utilizing mathematically and/or algorithmically generated barcode images presented on enabled mobile electronic devices to recipients and consumers of that information for a variety of uses including but not limited to data transfer, discount/coupon opportunities, and payment services. The invention relates to the dynamic creation of the displayed image; the display of the image; the act of scanning the dynamically generated image; the eventual conversion of the image into another form of readable data; and or the process of interacting with that data to consummate the reason for the transfer of data including but not limited to discount/coupon opportunities and other financial transactions. This invention is a combination of machine code, applications of machine code on electronic devices and their displays, and techniques applied thereto which enable successful barcode scanning using traditional barcode scanning equipment from the display of electronic devices.

### CROSS REFERENCES & REFERENCES

### CROSS-REFERENCE TO RELATED APPLICATIONS

This application claims the benefit of U.S. provisional application No 60/342,180, filed Dec. 20, 2001 (Whipple et al., Using Mobile Electronic Devices To Transfer Data Through Dynamically Generated Scannable Barcode Images); which is hereby incorporated herein by reference in its entirety.

U.S. Pat. Documents

| U.S. Pat. No. | Date | Inventor | Class |
|---|---|---|---|
| 3532184 | October, 1970 | Blake. | |
| 3716697 | February, 1973 | Weir. | |
| 3737631 | June, 1973 | Harris. | |
| 3746130 | July, 1973 | Bullas. | |
| 3836755 | September, 1974 | Ehrat. | |
| 3920100 | November, 1975 | Dunphy. | |
| 4373133 | February, 1983 | Clyne et al. | 235/383 |
| 4386272 | May, 1983 | Check et al. | 250/236 |
| 4509123 | April, 1985 | Vereen. | |
| 4578571 | March, 1986 | Williams | 235/472 |
| 4723212 | February, 1988 | Mindrum et al. | 364/401 |
| 4795281 | January, 1989 | Ulinski | 400/103 |
| 4803348 | February, 1989 | Lohrey et al. | 235/381 |
| 4814592 | March, 1989 | Bradt et al. | 235/381 |
| 4810867 | March, 1989 | Speicher | 400/103 |
| 4825045 | April, 1989 | Humble | 235/383 |
| 4833308 | May, 1989 | Humble | 235/383 |
| 4847641 | July, 1989 | Cheng-Yuan | 346/154 |
| 4864112 | September, 1989 | Imai | 400/104 |
| 4896791 | January, 1990 | Smith | 221/7 |
| 4908761 | March, 1990 | Tai | 364/401 |
| 4910672 | March, 1990 | Off et al. | 364/405 |
| 4916441 | April, 1990 | Gombrich | 340/712 |
| 4929819 | May, 1990 | Collins, Jr. | 235/383 |
| 4949256 | August, 1990 | Humble | 364/401 |
| 4960336 | October, 1990 | Brooks | 400/103 |
| 5008519 | April, 1991 | Cunningham et al. | |
| 5013896 | May, 1991 | Ono et al. | 235/381 |
| 5047614 | September, 1991 | Bianco | 235/385 |
| 5056429 | October, 1991 | Hirosaki | 400/103 |
| 5091634 | February, 1992 | Finch et al. | |
| 5101098 | March, 1992 | Naito | 235/379 |
| 5128520 | July, 1992 | Rando et al. | |
| 5173851 | December, 1992 | Off et al. | 364/401 |
| 5183343 | February, 1993 | Tazawa | 400/103 |
| 5185695 | February, 1993 | Pruchnicki. | |
| 5189291 | February, 1993 | Siemiatkowski | 235/472 |
| 5192854 | March, 1993 | Counts | 235/375 |
| 5208445 | May, 1993 | Nahar et al. | |
| 5221838 | June, 1993 | Gutman et al. | 235/379 |
| 5227614 | July, 1993 | Danielson et al. | 235/380 |
| 5227874 | July, 1993 | Von Kohorn | 358/84 |
| 5250789 | October, 1993 | Johnsen | 235/383 |
| 5268680 | December, 1993 | He | 250/566 |
| 5345071 | September, 1994 | Dumont | 235/472 |
| 5361871 | November, 1994 | Gupta et al. | 186/52 |
| 5380991 | January, 1995 | Valencia et al. | 235/383 |
| 5399844 | March, 1995 | Holland. | |
| 5401946 | March, 1995 | Weinblatt. | |
| 5397882 | March, 1995 | Van Solt | 235/381 |
| 5408077 | April, 1995 | Campo et al. | 235/383 |
| 5420606 | May, 1995 | Begum et al. | 345/146 |
| 5424524 | June, 1995 | Ruppert et al. | 235/462 |
| 5430558 | July, 1995 | Sohaei et al. | |
| 5438636 | August, 1995 | Surka | 382/279 |
| 5468942 | November, 1995 | Oosterveen et al. | 186/52 |
| 5468952 | November, 1995 | Alexander et al. | 235/492 |
| 5479535 | December, 1995 | Komatsu | 382/199 |
| 5488423 | January, 1996 | Walkingshaw et al. | 348/460 |
| 5500681 | March, 1996 | Jones | 348/473 |
| 5510604 | April, 1996 | England | 235/462 |
| 5523794 | June, 1996 | Mankovitz et al. | 348/460 |
| 5564841 | October, 1996 | Austin | 400/103 |
| 5581064 | December, 1996 | Riley et al. | 235/383 |
| 5594493 | January, 1997 | Nemirofsky | 235/375 |
| 5595264 | January, 1997 | Trotta, Jr. | 235/383 |
| 5597104 | January, 1997 | Elliott | 224/411 |
| 5612868 | March, 1997 | Off et al. | 364/214 |
| 5617982 | April, 1997 | Wilson | 224/411 |
| 5620079 | April, 1997 | Molbak | 194/217 |
| 5665953 | September 1997 | Mazzamuto, et al. | 235/383 |
| 5671374 | September, 1997 | Postman et al. | 395/309 |
| 5676473 | October, 1997 | Wright | 400/103 |
| 5697549 | December, 1997 | Yocum | 229/400 |
| 5701694 | December, 1997 | Atkinson | 40/493 |
| 5707680 | January, 1998 | Moore | 427/7 |
| 5708782 | January, 1998 | Larson et al. | 395/214 |
| 5710694 | January, 1998 | Chen | 361/703 |
| 5710886 | January, 1998 | Christensen et al. | 395/214 |
| 5890818 | April, 1999 | Sansone | 400/103 |

### Patent Applications

| | | |
|---|---|---|
| 20020060246 | May, 2002 | Gobburu et al. |

(claiming the benefit of U.S. Provisional Patent Application No. 60/252,101, filed Nov. 21, 2000)

| | | |
|---|---|---|
| 20020145043 | October, 2002 | Challa et al. |

(claiming the benefit of U.S. Provisional Patent Application No. 60/252,101, filed Nov. 21, 2000)

| | | |
|---|---|---|
| 20020161640 | October, 2002 | Wolfe |

(claiming the benefit of U.S. Provisional Patent Applications Serial No. 60/275,039, filed Mar. 307,138, filed Jul. 24, 2001)

| | | |
|---|---|---|
| 20020071076 | June, 2002 | Webb |

(claiming the benefit of U.S. Provisional Patent Application No. 60/225,805 filed on Aug. 16,

### OTHER REFERENCES

Uniform Symbology Specification PDF417, AIM USA, Pittsburgh, Pa., 1994.

Ink Spread and PDF417 Readability, Kevin Hunter, Symbol Technologies, Holtsville, N.Y.

Information Encoding with Two-Dimensional Bar Codes, Theo Pavlidis et al., Symbol Technologies, Holtsville, NY.

### Computer Program Listing

The accompanying CD contains a computer program example of the invention created using J2ME compliant code with the CLDC configuration and the MIDP profile. This code was successfully loaded and tested on a Nextel connected Motorola i85s cellular telephone with CLDC 1.0 and MIDP 1.0 installed in the java subsystem. While contrast and image control was minimally available, keys to successful scanning on this particular display were orientation of the barcode image and manual increase of contrast through standard phone menu controls.

This code created a successful test of the technology and encoding techniques below on the Nov. 15, 2001 although documented work on the code had begun the previous June. The prototype was used to purchase two bags of Hershey's chocolate chips utilizing a manufacturer $1.00 off coupon. The same code has been utilized numerous times subsequently with similar success. It has also been successfully tested on a Palm Pilot m505 PDA.

Not withstanding, this example application of the invention is not intended to limit the scope or applications thereof, as variations/modifications are possible. Alternatives and equivalents of the various elements of the code example may be apparent. These and other variations and modifications disclosed herein may be made without departing from the scope and spirit of the invention as set forth in the claims.

### BACKGROUND OF THE INVENTION

Manufacturers and retailers have long used printed coupons and rebates with barcode representations to deliver discounts to consumers. The coupons have typically been delivered by direct mail, or as an insert in a newspaper, or even in-store displays that contain printed coupons for use by customers. More recently, online coupon centers have been established which allow a customer to electronically find coupons (using a computer) and print them for use in the store (or in conjunction with online purchases).

The present invention allows a business to deliver a discount directly to the consumer electronically, and then allow the consumer to display the barcode image to a scanner used by a store clerk to receive the proof of coupon, without having to physically print the coupon at any point. It is well known that printing and distributing coupons is extremely expensive to manufacturers and fewer than 3% of coupons printed are redeemed. It is additionally believed that if coupons could be inexpensively delivered at the time of sale, they could be much more effective.

Although, not available to the public, numerous patents have been issued for devices which are capable of receiving bar code data, storing the data and then transmitting that data to a retail store. Generally, the interaction between the device and the retailer has been described as Infrared transmissions or wired transmissions and communication systems where the device is placed in a cradle. Additionally, some have provided “smart-card” based systems which are designed to store the data in a micro-processor chip and then transfer the data through a “smart card” reader device.

Common among all of these approaches are the need to either;

A. print a paper coupon at some point in the process, or

B. require the adoption of new hardware which is capable of causing interaction between the ‘device’ and the standard retail check-out equipment.

Magnetic stripe based credit and debit cards have been used for many years and have become an integral part of the payment system network throughout the developed world. In recent years, a remarkably innovative product generally referred to as a ‘smart card’ allows the functionality of magnetic striped based credit and debit cards with additional security and the ability to perform many additional functions—such as discounts, couponing and loyalty programs. The ‘smart card’ contains a microprocessor chip with various functions often including financial payment. The infrastructure required to allow business to interact with smart cards, however, is expensive. Converting point of sale systems from magnetic stripe card functionality to ‘smart card’ functionality industry-wide could potentially cost billions of dollars in the US market alone.

U.S. Pat. No. 6,129,274 to Suzuki provides a smart card device which allows interaction between customer and retail store to provide transactional and demographic information which may or may not include promotions.

The present invention allows consumers to convert the ‘electronic dialogue’ of the smart card to a barcode representation that would allow the smart card financial payment tool to interact with existing point of sale scanning infrastructure without expensive modifications to point of sale devices. In addition, the invention allows for a similar payment method without the need of a smart card financial payment tool by utilizing an enabled mobile electronic device to serve as the mechanism for payment. Appropriate security, authorization and authentication measures can be programmatically built into the enabled mobile electronic device. The invention allows an intelligent payment alternative without the need of a new infrastructure.

The utilization of personal computers has also been suggested to more efficiently deliver coupons to consumers:

U.S. Pat. No. 6,237,145 to Narasimhan, et al provides electronic means of “clipping” coupons and then reduces the coupon to a printed paper form for redemption by the retail store.

U.S. Pat. No. 6,321,208 to Barnett, et al. provides additional security to the process of electronically sourcing coupons and then reducing them to a printed form.

U.S. Patent Application 20010001145 provides a printed coupon which is delivered electronically, and then through the redemption process, additional demographic data with respect to the consumer is passed to the retailer.

Mobile Electronic Devices have become popular and efforts have been made to devise methods of utilizing these tools for the delivery of coupons.

U.S. Pat. No. 5,047,614 to Bianco provides the customer with a scanner or portable terminal capable of scanning bar codes of various products at the customer's residence. The customer takes his portable terminal to the retail store and connects it with a host computer at the store. The host computer will print out a list for the customer or, as described in another embodiment of the invention, the host computer will transmit the list of desired items to a warehouse where the customer's order is manually or automatically packaged and moved to a pick-up location along with the total invoice for payment of the items selected.

U.S. Pat. No. 4,373,133 to Clyne, et al. provides a portable scanner which attaches to the shopping carts used in a retail grocery stores. As the customer selects the items and deposits them in their shopping cart, they use a wand to scan the barcode printed on the item. The scanner device is adapted to read both the price and the weight of the selected item. Thus, when the customer proceeds to the sales terminal, the total weight of their purchases is compared to the total weight displayed by the scanner. If the weights are in agreement, the sales clerk then produces a bill on the cash register equal to the total price shown on the scanner.

U.S. Pat. No. 5,595,264 to Trotta, provides a barcode scanner which is released to the customer after an authorized credit card, debit card or like payment medium is accepted. The customer then proceeds to shop along the aisles of the retail store and scans the bar code indicia on the desired items. When the customer pushes a button on the scanner to confirm the purchase of a scanned item, the indicia code information is transmitted to an in-store computer. The computer performs the functions of adding the purchased item to the customer's total bill and receipt, debiting the item from the customer's payment card for the price of each item as it is scanned, adjusting the inventory total within the store.

U.S. Pat. No. 5,665,953 to Mazzamuto, et al. provides a self-contained personal data collector used for scanning coupons and then an application for managing the coupons and then a method for transferring that data to the register at check-out. The preferred embodiment visualizes an infra-red transfer of data from the data-collection device to equipment provided and the check-out register. In all embodiments, a transfer of code is described through either a wireless or wire based method.

U.S. Pat. No. 5,905,246 to Fajkowski provides a “coupon card” device comprised of a scanner, display, keyboard and memory, which is capable of scanning coupons, downloading coupons from multiple electronic sources, storing coupons and then connecting to a peripheral device at the check-out counter at the retail store, where the data is presented, used coupons are removed from the device and the coupons are credited appropriately to the customer's purchase.

The barcode scanning devices utilized in these procedures are well known, and understood.

U.S. Pat. No. 4,578,571 to Williams provides detail of the mechanism involved.

These scanners may operate on ultrasonic, microwave, infrared, or radio frequency.

Numerous innovations are noted with respect to the development of the barcode and the printing thereof

U.S. Pat. No. 5,890,818 to Sansone describes methodology with respect to refining the printing process by which bar codes are printed to maximize readability as they are scanned by bar code scanners.

In spite of the common use of bar codes and the technologies surrounding them, the ability to use a typical bar code scanner to read a bar code presented on the typical display of an electronic device such as a PDA, cell phone, television or computer has been problematic.

Conventional industry wisdom is that a conventional scanner will simply not read light emitting electronic displays presenting images of bar codes.

U.S. Patent Application 20020161640 filed by Wolfe states “. . . a bar code cannot be scanned directly with conventional scanners from an LCD display, such as is typically found on a cellular telephone or PDA . . . ” and proposes the use of a specialized display which can transmit a scannable code.

U.S. Patent Application 20020071076 filed by Webb describes the problems with reading standard displays in some detail; and proposes the use of a lens or film to be placed over a standard display, described as a “quarter wave retarder which allows light from the scanner to penetrate the LCD for scanning the displayed barcode. The retarder may be manufactured as part of the LCD, or may be removably attached to the LCD such as with a plastic static strip or removable face plate.”

U.S. Patent Application 20020145043 filed by Challa describes a fob device which displays a barcode to be scanned. Specialized circuitry is recommended, together with regulation of electrical flow. Additionally suggestions are made as to brightness, contrast and the use of color.

No specific code or application is offered which can be reliably applied to existing display devices for the scannability of bar code images.

U.S. Patent Application 20020060246 filed by Gobburu, assumes that the typical LCD or TFT type displays can be read by scanners, and lists, generally, methods which could potentially be employed to improve the display. Contrast, brightness and colors are again mentioned, as well as the pulsing of light, rather than displaying an image.

Again, a reliable specific approach has not elsewhere been offered to solve this challenging problem.

The present invention provides the specific code, methods, techniques and applications that reliably generate a scannable bar code image on existing electronic display devices.

### BRIEF SUMMARY OF THE INVENTION

The present invention relates to the field of mobile electronic apparatus with display capability to render a machine-readable image suitable for scanning and more particularly to mobile electronic apparatus displaying barcode images for purposes of transferring data from a data provider to a data recipient utilizing various scanning technologies. The invention includes; machine code, systems, methods, techniques and applications for generating and presenting a scannable barcode image on a mobile electronic device; whereby that image may be scanned by traditional barcode scanners and used for the transfer of data and/or in commerce.

### BRIEF DESCRIPTION OF DRAWINGS

The figures are meant to be representative of the domain of the invention, and illustrative of various embodiments thereto. It should be understood, however, that the invention is not limited to the precise arrangements and instrumentalities shown in the drawings, wherein:

FIG. 1 is a general overview of a data transfer capability wherein a data provider may use a variety of tools to gather, generate and confirm the information to be transferred and where the mobile device can communicate with external entities for various reasons during the transfer.

FIG. 2 is a presentment of a barcode on a cellular phone device.

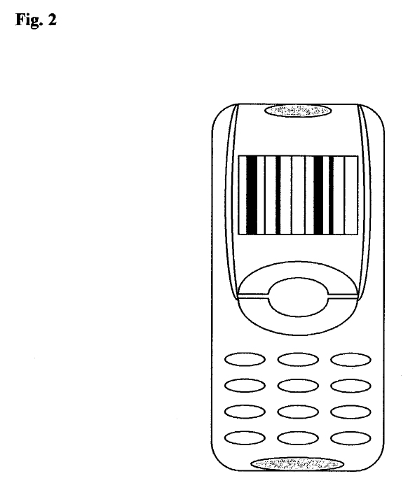

### DETAILED DESCRIPTION OF THE INVENTION

It is an object of the invention to provide a simple to use system enabling data providers to communicate information to data recipients utilizing dynamically generated displays of machine readable information (such as barcodes).

It is an object of the invention to provide a set of tools to enable data providers to communicate information to consumers, which can then be used by those consumers to effectuate data transfers to other entities with which they have business.

It is an object of the invention to provide a system that will execute utilizing existing scanning infrastructure.

It is an object of the invention to provide a simple-to-use system that requires little or no training of personnel related to the scanning of the images.

It is an object of the invention to provide a more efficient method of transferring bar code data which may include the expression of multiple codes within a single code.

It is a further object of the invention to provide a secure environment in which data transferred can be easily and safely stored, transferred and retrieved.

These and other objects are accomplished by creating a set of technical tools, software, procedures, protocols, and databases to enable data providers and recipients to communicate effectively and quickly, utilizing a wide variety of current and future mobile electronic devices to display the information to be communicated. The invention includes software for the communication and creation of the barcode imagery. The invention also includes a database of barcode encoding techniques that can be dynamically loaded onto the mobile electronic device to provide selection of which barcode encoding technology to use for a given transaction. In addition, it includes security mechanisms to allow information to be stored locally and securely on the mobile electronic device. The invention also covers a set of protocols and procedures governing the communications needs associated with transferring data and confirming and authorizing the transfer.

Specifically the object of the invention is to enable the display on standard displays such as LCD (liquid crystal display), CRT (cathode ray tube), or TFT (thin film type) displays, as are commonly found on Personal Digital Assistants (“PDAs”),Two-Way Pagers, Internet appliances, including consumer wireless Internet access devices (“CADs”), Cellular phones, GSM phones, WAP-enabled phones, Personal Communication System (“PCS”) phones, Multi-function wireless “smart” phones, Wireless Internet Devices (“WID”), Personal Viewing Devices (eyeglass display), Computer Monitors and Television screens; of a code (bar code) which can be scanned and interpreted by standard scanners which are widely available.

Machine code is presented below which utilizes the following techniques to display an image that can be scanned and interpreted by standard bar code scanning devices on an existing LCD display such as that found on a Motorola i85s Cellular Telephone.

Important components of presenting a scannable images include the following:

Higher resolution with respect to the features being displayed;

Properly adjusted contrast on said medium to produce maximum readability of the bars;

Brightness optimized on said medium to facilitate the interaction of light in the readability of the bars;

Background and foreground interplay designed to optimize the readability of the bars;

Use of colors/shades for successful readability of the bars;

Display characteristics which act to reduce conflicts between the light emitted from the display and the light or other waves emitted from the scanning device;

Presentation of bytes of data representing bar code characteristics in a reliable and replicable manner;

Control of the location of pixelation and/or the emittance of light by the bytes of data to produce machine-readable bars;

Utilizing the supplied information and said property to control the display characteristics so as to produce bars having the desired bar width, length contrast, brightness, and light emitting and refracting properties;

Application of techniques and applications to produce the desired display characteristics of bars with the proper width;

Presentation of the desired display characteristics of bars having at least two parallel sides;

Presentation of the desired display characteristics of bars having at least four parallel sides;

Presentation of the desired display characteristics of bars having the correct length;

Presentation of the desired display characteristics of bars with the proper distance between the bars;

Presentation of the desired display characteristics of bars whereby the distance between adjacent bars is constant; and

Code which specifically optimizes the above features in currently available electronic devices.

### DETAILED DESCRIPTION OF PREFERRED EMBODIMENTS

The preferred embodiments are designed to prove illustrative to assist interested parties in being able to understand the invention and the uses to which it may be put. It should be understood, however, that the invention is not limited to the precise arrangements and instrumentalities described in the embodiments, wherein:

Embodiment I

(Transfer of Data from a Data Provider to a Data Recipient)

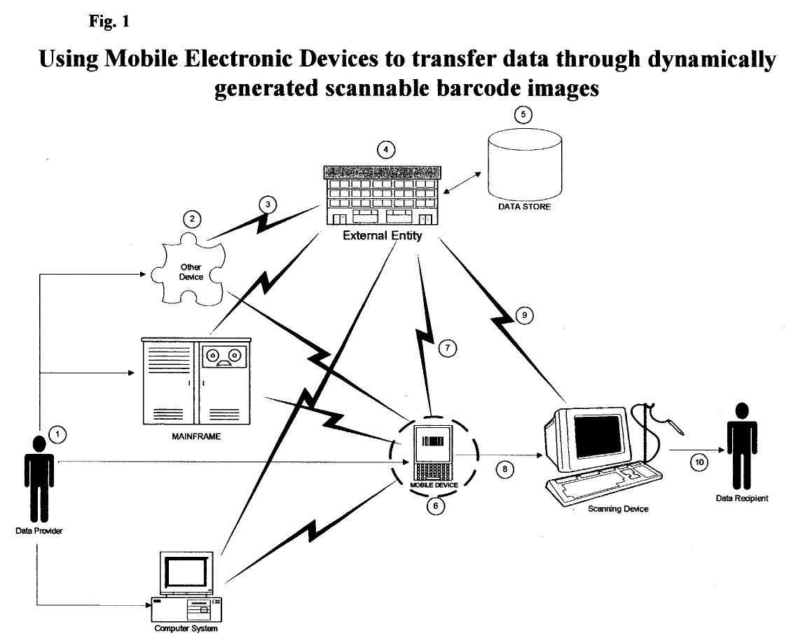

Illustration—FIG. 1

FIG. 1 is illustrative of the broad use of the invention, which is the transfer of data from a data provider to a data recipient as follows:

\mathring{1}—A data provider determines the need or desire to communicate data. This data communication can be for the purposes of simple data transfer, the communication of discount/coupon opportunities, as a payment alternative, or as the inception of a query against external data sources.

\mathring{2}—The data provider utilizes whatever tools are necessary to create an electronic representation of the data to be transferred. These tools can be personal computers, “mainframe” computer systems, mobile electronic devices, or other appropriate devices to be determined. The data so created can be encoded, encrypted or manipulated in such a fashion as to be friendly to the public, private, general or proprietary final or interim recipient of the data.

\mathring{3}—The tools may require communication to an external entity for purposes of authentication or for addition information beyond that in the immediate possession of the data provider. Said communication could occur through wired or wireless public or private topography, using public or private communications standards over public or private communications mechanisms such as networks or telecommunications.

\mathring{4}—The external entities can be any service or organization needed to assist in the data transfer such as a financial institution, inventory system, or other data source.

\mathring{5}—The external entity may also rely on data stores at their location or at other locations that maintain the information desired by the data provider.

\mathring{6}—The primary core of the invention is the ability to represent the desired data on a mobile electronic device utilizing barcode technology represented by dynamically created and mechanically or electronically readable barcodes encoded in any public or private barcode encoding standard.

\mathring{7}—If information is created directly onto the mobile electronic device, the mobile electronic device may also communicate via wired or wireless public or private networks to a variety of external entities for purposes of data collection, verification, authentication, or validation.

\mathring{8}—A scanning device of mechanical or electronic technologies can be utilized to read the barcode image presented on the mobile electronic device and may be captured on the scanning device for immediate use, or for capture and later processing.

\mathring{9}—The scanning device may also require communication to external entities for purposes of authentication or for addition information beyond that scanned by the scanning device from the image presented by the mobile electronic device. Said communication could occur through wired or wireless public or private topography, using public or private communications standards over public or private communications mechanisms such as networks or telecommunications.

\mathring{10}—The Data Recipient is then in possession of the information communicated and can then use the communicated information for whatever purposes desired.

Embodiment II

(Customer Transfer of Coupon Barcode to Vendor—and Subsequent Payment)

Where a Customer, who has access to an enabled mobile electronic device with appropriate software, wishes to purchase a product from a Vendor:

The customer utilizes the enabled mobile device to search for discounts (using wired or wireless communications). The search may occur at the time of the purchase, or as a preparation before the purchase. And the search may occur on the enabled mobile electronic device itself, or on any other device capable of performing the search and transferring the data to the mobile device. The search may even be done manually by the customer and the alphanumeric code representing the discount may be physically entered into the mobile electronic device.

If discounts are discovered, the data representing that discount is downloaded to the enabled mobile electronic device.

At the appropriate time, the Customer instructs the mobile electronic device to display a barcode representation of the discount. The representation may be of an electronic re-creation of a paper coupon or an electronic-only coupon.

The Vendor's Point-Of-Sale (POS) device recognizes and registers the scanned barcode image (as with any paper coupon).

The electronically generated barcode representation of the discount may then be automatically expired (using a timeout capability) or may be expired by a keypress.

The enabled mobile electronic device may relay usage information about the electronic coupon's presentation back to the location from which the electronic coupon information was extracted.

Once all purchase activity is completed, the customer may instruct the enabled mobile electronic device to create a final barcode image representing a virtual payment coupon for any portion or the entire amount of the purchase (alternative form of payment). From the vendor's perspective, the barcode is accepted as any other coupon, which may be redeemed using typical redemption methods for retail coupons, or through a specific arrangement with the financial services provider—to whit:

The financial payment tool may be a direct contact between the mobile device and a financial institution, or more likely a ‘smart card’ payment device, which is resident in the mobile electronic device, or is inserted, in the mobile electronic device.

When the customer initiates a payment request, the mobile enabled device may require authentication through the use of a PIN (personal identification number), password, or biometric device such as handwriting, voice, finger, hand, or eye (iris scan). Additionally, it may request authorization through a networked or telephonic (usu. Wireless) connection to an appropriate financial clearing agency (i.e. bank, financial agency, network such as Visa or MasterCard, etc . . . ).

Once the authentication is received, the invention calculates the appropriate barcode for display using mathematical or algorithmic programs residing on the enabled mobile electronic device.

The final barcode is presented to the POS terminal for scanning and appropriate application to the bill.

The vendor may require additional authentication through the use of a PIN (personal identification number), password, or biometric device such as handwriting, voice, finger, hand, or eye (iris scan).

If the entire bill is not paid, the customer may pay the remainder of the bill through alternate methods.

At the time the enabled electronic mobile device next interacts with the appropriate couponing and/or other agency, all purchase and discount activities are recorded for verification of coupon redemption requests.

The vendor directs redemption requests for all honored coupons, including the virtual payment coupon to the appropriate entities.

Embodiment III

(Customer Data Receipt from Vendor, as an Integral Part of Embodiment II, Above)

The Vendor from Embodiment II above, desires to transmit data back to the customer.

The Vendor either 1) creates data within their local equipment, 2) downloads data from an exterior source, or 3) inserts a device, such as a smart card into the local equipment, to use the equipment for transferring data to the Customer.

The Vendor then encodes, or converts to a transmittable form the data described above.

At the appropriate time, the Vendor transmits data to the Customer's mobile electronic device.

The Customer's mobile electronic device recognizes and registers the received data

If the data is secured, the mobile enabled device may require authentication through the use of a PIN (personal identification number), password, or biometric device such as handwriting, voice, finger, hand, or eye (iris scan).

Once the authentication is received, the Customer determines whether to view or discard information received.

If the data is to be viewed, the mobile electronic device decodes the information. Once decoded, the mobile electronic device displays the information.

Embodiment IV

(Provider Data Transfer Through Data Barcode to Recipient)

Where a data Provider, who has access to an enabled mobile electronic device with appropriate software, wishes to transfer data to a Recipient:

The Provider either 1) creates data within the mobile device, 2) downloads data from an exterior source, or 3) inserts a device, such as a smart card into the mobile device, to use the device as a conduit for transferring data to the Recipient.

At the appropriate time, the customer instructs the mobile electronic device to display a barcode representation of the data.

The Recipient's scanning device recognizes and registers the scanned barcode image.

The electronically generated barcode representation of the data may then be automatically expired (using a timeout capability) or may be expired by a keypress.

If the data is secured, the mobile enabled device may require authentication through the use of a PIN (personal identification number), password, or biometric device such as handwriting, voice, finger, hand, or eye (iris scan).

Once the authentication is received, the invention calculates the appropriate barcode for display using mathematical or algorithmic programs residing on the enabled mobile electronic device.

The final barcode is presented to the Recipient for scanning.

The vendor may require additional authentication through the use of a PIN (personal identification number), password, or biometric device such as handwriting, voice, finger, hand, or eye (iris scan).

The Recipient uses resident software to convert the data or transfers the data to a facility that is equipped to convert the data to a usable form.

Embodiment V

(Provider Data Receipt from Recipient, as an Integral Part of Embodiment IV, Above)

The Recipient of Data from Embodiment IV, above, desires to transmit data back to the original Provider.

The Recipient either 1) creates data within their local equipment, 2) downloads data from an exterior source, or 3) inserts a device, such as a smart card into the local equipment, to use the equipment for transferring data to the Recipient.

The Recipient then encodes, or converts to a transmittable form the data described above.

At the appropriate time, the Recipient transmits data to the Provider's mobile electronic device.

The Provider's mobile electronic device recognizes and registers the received data

If the data is secured, the mobile enabled device may require authentication through the use of a PIN (personal identification number), password, or biometric device such as handwriting, voice, finger, hand, or eye (iris scan).

Once the authentication is received, the Provider determines whether to view or discard information received.

If the data is to be viewed, the mobile electronic device decodes the information.

Once decoded, the mobile electronic device displays the information.

Embodiment VI

(Business Transfers Discount at the Request of Customer)

Where a User determines that they may be interested in purchasing a product or service;

The User creates a discount request notice using an appropriate tool capable of creating the request by identifying the product or service in which they have an interest, as well as the approximate timeframe of the purchase.

The discount request notice is transmitted to a discount clearinghouse or directly to the manufacturer or vendor (each of these is referred to hereinafter as ‘Business’), by the User through the use of an appropriate tool.

The discount request notice is received by the Business.

If a discount is not available, the request receives a negative reply.

If a discount is available, the Business identifies an appropriate code to transmit to the User.

The appropriate code is transmitted to the User.

The User receives notice that the request has been fulfilled.

If the code is not transmitted directly to a mobile electronic device, the User transfers the data to a mobile electronic device.

At the Point of Sale, the User determines whether or not to present the discount.

If the User intends to present the discount, the mobile electronic device, through the invention, converts the code to a dynamically displayed barcode.

The display of the mobile electronic device is then presented to the Recipient's POS scanner for processing.

The mobile electronic device automatically expires the discount and batches expiration details for transmittal to the issuer of the discount for reconciliation against discount remittance requests. Alternatively, the discount may be expired by a keypress so that additional discounts may be applied to the same purchase with each discount expiration detail being batched for transmittal to the discount issuer.

The mobile electronic device communicates to the discount issuing agency as soon as possible to communicate discount expiration detail for discounts used.

The Recipient's POS device creates a reconciliation and remittance request for each discount agency.

The Recipient communicates the remittance request to the appropriate discount agency.

The discount agency validates the remittance request against batches received from mobile electronic devices and through other means.

The discount agency initiates a funds transfer from its financial institution to the Recipient to compensate them for the discount.

Embodiment VII

(Business Transfers Discount Unsolicited by Customer)

Vendor or Manufacturer determines a product or service on which they wish to offer a discount.

Vendor or Manufacturer identifies individually, algorithmically, generally, or through some other method to which Users they wish to grant this discount.

Vendor or Manufacturer creates a marketing program to generate the discount information and transmit it to the Users identified either directly or through the use of a discount clearinghouse and marketing service.

Clearinghouse, Vendor, or Manufacturer encodes information associated with discount marketing program.

Clearinghouse, Vendor, or Manufacturer broadcasts information to specified Users' mobile devices.

Users receive notification of receipt of information.

At the Point of Sale, the User determines whether or not to present the discount.

If the User intends to present the discount, the mobile electronic device, through the invention, converts the code to a dynamically displayed barcode.

The display of the mobile electronic device is then presented to the Recipient's POS scanner for processing.

The mobile electronic device automatically expires the discount and batches expiration details for transmittal to the issuer of the discount for reconciliation against discount remittance requests. Alternatively, the discount may be expired by a keypress so that additional discounts may be applied to the same purchase with each discount expiration detail being batched for transmittal to the discount issuer.

The mobile electronic device communicates to the discount issuing agency as soon as possible to communicate discount expiration detail for discounts used.

The Recipient's POS device creates a reconciliation and remittance request for each discount agency.

The Recipient communicates the remittance request to the appropriate discount agency.

The discount agency validates the remittance request against batches received from mobile electronic devices and through other means.

The discount agency initiates a funds transfer from its financial institution to the Recipient to compensate them for the discount.

Embodiment VIII

(User Initiated Payment Processing)

Where the User determines that they wish to use a mobile electronic device as a payment presentment and processing device.

The User may instruct the enabled mobile electronic device to create a barcode image representing a virtual payment for any portion or the entire amount of a purchase.

To initiate the financial transaction, communications may occur between the mobile device and a financial institution, or more likely a ‘smart card’ payment device, which is resident in the mobile electronic device, or is inserted in the mobile electronic device.

When the customer initiates a payment request, the mobile enabled device may require authentication through the use of a PIN (personal identification number), password, or biometric device such as handwriting, voice, finger, hand, or eye (iris scan). Additionally, it may request authorization through a networked or telephonic (usu. Wireless) connection to an appropriate financial clearing agency (i.e. bank, financial agency, network such as Visa or MasterCard, etc . . . ).

If funds are available for payment, the authentication process may be completed

Once the authentication is recognized by the mobile electronic device, the invention calculates the appropriate barcode for display using mathematical or algorithmic programs residing on the enabled mobile electronic device.

The final barcode is presented to the Recipient's POS terminal for scanning and appropriate application.

The Recipient may require additional authentication through the use of a PIN (personal identification number), password, or biometric device such as handwriting, voice, finger, hand, or eye (iris scan).

The electronically generated barcode representation of the payment may then be automatically expired (using a timeout capability) or may be expired by a keypress.

When the barcode is expired, the received authorization code is displayed for notation and recorded by the POS operator, or automatically stored by the Recipient's local equipment (as with a typical financial transaction).

At the time the enabled electronic mobile device next interacts with the financial institution, all purchase and receipt activities are recorded.

From the Recipient's perspective, the barcode is accepted as any coupon or other barcode based discount, which may be redeemed using typical redemption methods for retail coupons, or through a specific arrangement with a financial services provider.

The Recipient requests payments from the appropriate entities.

The User's financial institution validates the remittance request information received from the User's mobile electronic device, as standard business practice and compares with payment request from Recipient.

The User's financial institution initiates a funds transfer from the User's account in fulfillment of the commitment identified by the authorization code.

The User's financial agency adjusts the User's account, as appropriate.

The description of the embodiments set forth herein is illustrative of applications of the invention and is not intended to limit the scope thereof, as variations/modifications are possible. Alternatives and equivalents of the various elements of the embodiments may be apparent from this description. These and other variations and modifications of the embodiments disclosed herein may be made without departing from the scope and spirit of the invention as set forth in the claims.

We claim:

1. The machine code and the techniques utilized in developing the machine code and the application for forming bars of a bar code on the display of an electronic device, such that the bar code rendered is scannable by barcode scanning devices as are commonly used, comprising:
means for producing a higher resolution with respect to the features being displayed;
means for controlling the contrast on said medium to produce maximum readability of the bars;
means for controlling the brightness on said medium to optimize the readability of the bars;
means for varying the background and foreground to optimize the readability of the bars;
means for displaying the optimized colors/shades for successful readability of the bars;
means for reducing conflicts between the light emitted from the display and the light or other waves emitted from the scanning device;
means for supplying information regarding characteristics of said medium of the bars to be formed;
means for supplying information specifying the desired bar code characteristic; and

2. The code, techniques and applications claimed in claim 1, wherein the using means includes: means for producing a higher resolution with respect to the features being displayed.

3. The code, techniques and applications claimed in claim 1, wherein the using means includes: means for controlling the contrast on said medium to produce maximum readability of the bars.

4. The code, techniques and applications claimed in claim 1, wherein the using means includes: means for controlling the brightness on said medium to optimize the readability of the bars.

5. The code, techniques and applications claimed in claim 1, wherein the using means includes: means for varying the background and foreground to optimize the readability of the bars.

6. The code, techniques and applications claimed in claim 1, wherein the using means includes: means for displaying the optimized colors/shades for successful readability of the bars.

7. The code, techniques and applications claimed in claim 1, wherein the using means includes: means for reducing conflicts between the light emitted from the display and the light or other waves emitted from the scanning device.

8. A method for forming bars of a bar code, said method comprising the steps of:
producing bytes of data representing specific bar code characteristics;
controlling the location of pixelation and or the emittance of light required by the data to produce machine-readable bars;
supplying information of the bars to be formed; and
using the supplied information and said property to control the display characteristics so as to produce bars having the desired bar width, length contrast, brightness, color (wavelength), and light emitting and refracting properties.

9. The method claimed in claim 8, wherein the machine code, techniques and applications produce the desired display characteristics of bars with the proper width.

10. The method claimed in claim 8, wherein the machine code, techniques and applications produce the desired display characteristics of bars having at least two parallel sides.

11. The method claimed in claim 8, wherein the machine code, techniques and applications produce the desired display characteristics of bars having at least four parallel sides.

12. The method claimed in claim 8, wherein the machine codes, techniques and applications produce the desired display characteristics of bars having the correct length.

13. The method claimed in claim 8, wherein the machine code, techniques and applications produce the desired display characteristics of bars with the proper distance between the bars.

14. The method claimed in claim 8, wherein the machine code, techniques and applications produce the desired display characteristics of bars whereby the distance between adjacent bars is constant.
